(19) United States
(12) Patent Application Publication
(10) Pub. No.: US 2006/0170174 A1
(43) Pub. Date: Aug. 3, 2006

(54) Skate board

(76) Inventor: Yuji Hiramatsu, Shizuoka (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(21) Appl. No.: 10/539,240

(22) PCT Filed: Jul. 30, 2004
(86) PCT No.: PCT/JP04/10970

§ 371 Date: Dec. 14, 2005

(30) Foreign Application Priority Data
Aug. 7, 2003 (JP) 2003-288916

(51) Int. Cl. B62M 1/00

(52) U.S. Cl. 280/87.041

(57) ABSTRACT

A skateboard is constructed to provide a natural ride and good operability without adversely influencing a motor controller and batteries. The skateboard includes a board, wheels provided on a bottom side of the board at front and rear regions thereof, a motor controller for supplying the wheels with rotary power, a case provided on a bottom side of the board and housing the motor controller, and fixing bolts fixing an approximately central region of the case to the board, leaving front and rear end regions of the case free.

### BACKGROUND OF THE INVENTON

1. Field of the Invention

The present invention relates to a skateboard, and more specifically, the present invention relates to a powered skateboard which includes a drive wheel supplied with rotary power by a drive motor.

2. Description of the Related Art

Conventionally, powered skateboards that are driven by a drive motor are known, an example of which is disclosed in JP-A 2000-140190, which is hereinafter referred to as Patent Document 1.

According to the powered skateboard disclosed in Patent Document 1, the drive motor and the drive wheel supplied with rotary power by the drive motor are provided on a bottom side of the board. Further, a motor controller, which includes a controller for controlling the motor, a battery as a power source and so on, is attached to a bottom surface of the board.

According to this technique, however, the controller and the battery are attached entirely and integrally with the board. Therefore, when the board is used and as the board is deformed by the rider's weight, the deformation load, for example, acts directly on the controller or the battery, potentially causing an adverse influence on the controller or the battery.

In order to reduce the deformation of the board, the board may be made of a material which has a high strength/rigidity rather than a flexible structural material, or the board may be provided with a reinforcing member for enhanced strength/rigidity. However, superior strength/rigidity will lead to unnatural riding and operability.

### SUMMARY OF THE INVENTION

In order to overcome the problems described above, preferred embodiments of the present invention provide a skateboard that provides a natural ride and good operability without adversely influencing a drive power controller such as a controller and a battery.

According to a preferred embodiment of the present invention, a skateboard includes a board, wheels provided on a bottom side of the board at front and rear regions thereof, a motor controller arranged to supply at least one of the wheels with rotary power, a case provided on a bottom side of the board and housing the motor controller, and a fixing element arranged to fix a center region of the case to the board, leaving front and rear end regions of the case free.

According to a preferred embodiment of the present invention, an approximately central region of the case is fixed to the board by the fixing element, and the front and the rear ends of the case are free ends. Therefore, for example, when the rider applies a load onto the board, causing the approximately central region of the board to be displaced (flexed) in vertical directions on the front and the rear wheels serving as fulcrum points, the case does not deform so there is no adverse influence on the motor controller, which may include a controller and a battery. Further, since the board is not subject to a resisting force from the case against the deflection of the board, good operability by the rider's feet is obtained, and a natural comfortable ride can be assured due to suspension.

According to another preferred embodiment of the present invention, a skateboard includes a board, wheels provided on a bottom side of the board at front and rear regions thereof, a motor controller arranged to supply at least one of the wheels with rotary power, a case provided on a bottom side of the board and housing the motor controller, and a support member arranged to support the case on the bottom side of the board, and move longitudinally relative to the board at least when a load is applied on the board.

According to this preferred embodiment of the present invention, even if the rider applies a load onto the board and causes the generally central region of the board to be displaced (flexed) in vertical directions, the support member of the case moves in fore-and-aft directions (longitudinally of the board) in accordance with the amount of displacement, reducing the deformation load, vibration, force, etc. that is applied to the case. Use of the skateboard under such a condition does not deform the case, so there is no adverse influence on the motor controller, which may include, for example, a controller, a battery and other elements. Further, since the board is not subject to a resisting force from the case against the deflection of the board, good operability by the rider's feet is obtained, and a natural comfortable ride can be assured due to suspension.

Preferably, the skateboard further includes a weight transfer detection sensor for detecting weight transfer of a rider riding on the board. The motor controller is preferably arranged to supply the wheel with the rotary force in accordance with a detection signal from the weight transfer detection sensor. In this case, good driving control of the wheel in accordance with the weight transfer of the rider can be achieved.

Further, preferably, the board is made of a flexible structural material. In this case, the board flexes in vertical directions, making it possible to further improve operability by the rider's feet, further improve riding comfort due to suspension, and contribute to reduced weight.

The present invention is advantageous when the motor controller includes a controller or a battery which is susceptible to bending.

Further, preferred embodiments of the present invention are advantageous when the controller includes a plurality of batteries which are electrically connected with each other. Since each battery is heavy, the electrical connection between the batteries is likely to be cut by applied stress. However, according to preferred embodiments of the present invention, the case does not deform, and thus does not exert stress on the batteries, preventing such a problem.

The term “skateboard” used in the description of preferred embodiments of the present invention means a mobile body which includes a plurality of wheels and a board disposed thereon, for a rider to ride on an upper surface of the board to transport.

Other features, elements, characteristics and advantages of the present invention will become more apparent from the following detailed description of preferred embodiments thereof with reference to the attached drawings.

### BRIEF DESCRIPTION OF THE DRAWINGS

FIG. 1 is a perspective view showing a preferred embodiment of the present invention.

FIG. 2 is a side view showing a skateboard without an intermediate portion.

FIG. 3 is a schematic diagram of a section, showing how a front wheel which serves as a free wheel is attached.

FIG. 4 is a conceptual diagram of a section, showing a construction of a rear wheel which serves as a drive wheel, and how it is attached.

FIG. 5 is a conceptual diagram of a section, showing the inside of a case and how the case is attached.

FIG. 6 is a conceptual diagram as a plan view, showing an inside of the case.

FIG. 7 is a controller block diagram of the skateboard.

FIG. 8 is a conceptual diagram showing how the case is supported when no load is applied in the preferred embodiment in FIG. 1.

FIG. 9 is a conceptual diagram showing how the case is supported when a load is applied in the preferred embodiment in FIG. 1.

FIGS. 10(a) and 10(b) illustrate a primary portion of another preferred embodiment of the present invention, wherein FIG. 10(a) is a conceptual diagram as a side view, and FIG. 10(b) is a conceptual diagram as a bottom view.

FIG. 11 is a perspective view of the case used in the preferred embodiment shown in FIGS. 10(a) and 10(b).

FIG. 12 is a conceptual diagram showing how the case is supported when no load is applied in the preferred embodiment shown in FIGS. 10(a) and 10(b).

FIG. 13 is a conceptual diagram showing how the case is supported when a load is applied in the preferred embodiment shown in FIGS. 10(a) and 10(b).

FIGS. 14(a)-14(c) illustrate another preferred embodiment of the present invention in which FIG. 14(a) is a conceptual diagram as a plan view, FIG. 14(b) is a conceptual diagram showing how the case is supported when no load is applied, and FIG. 14(c) is a conceptual diagram as a bottom view.

FIG. 15(a) is a conceptual diagram showing how the case is supported when a load is applied in the preferred embodiment of FIGS. 14(a)-14(c), and FIG. 15(b) is a conceptual diagram as a bottom view.

FIG. 16 is a conceptual diagram of a section, showing a case housing two controllers.

### DETAILED DESCRIPTION OF PREFERRED EMBODIMENTS

Hereinafter, preferred embodiments of the present invention will be described with reference to the drawings.

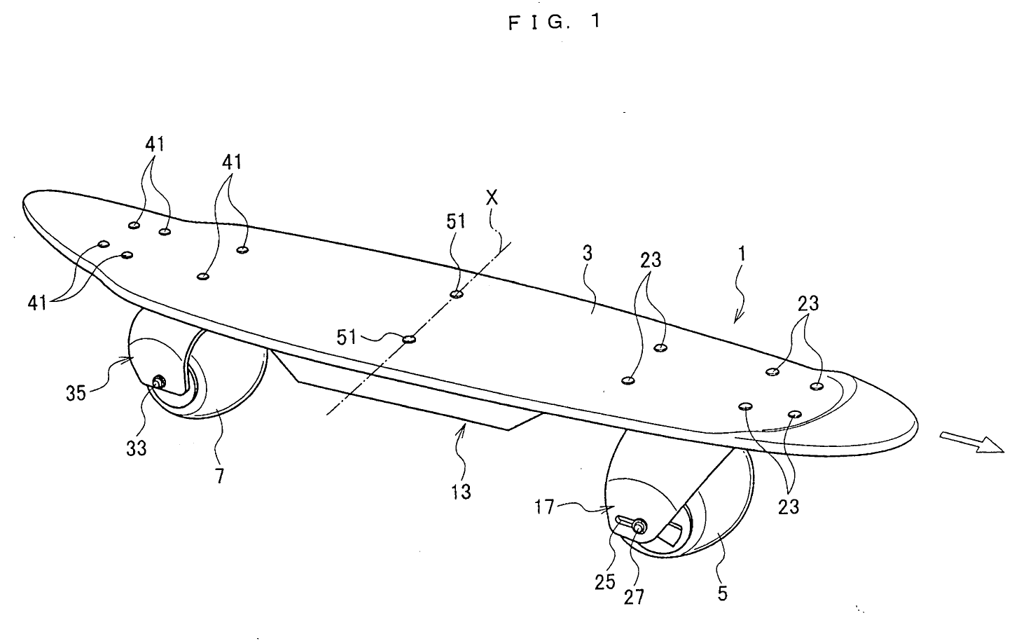

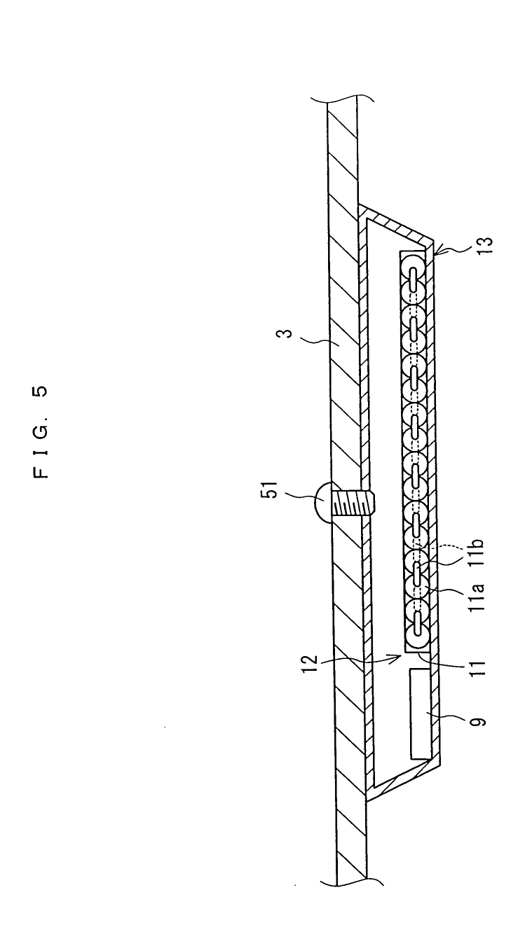

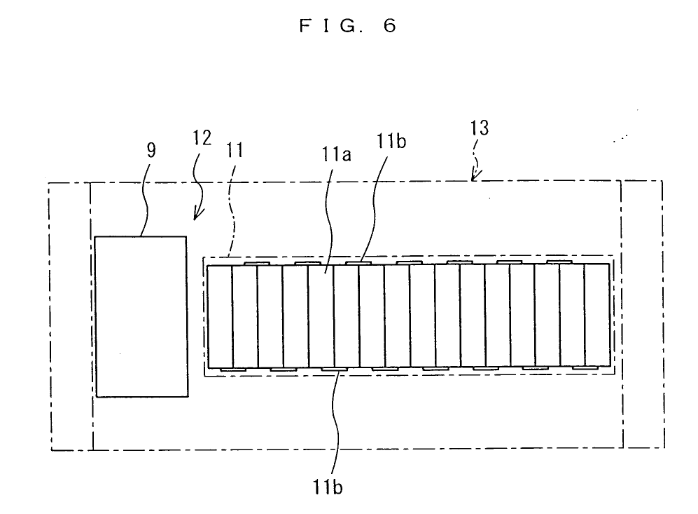

Referring to FIG. 1, a skateboard 1 according to a preferred embodiment of the present invention includes a board (deck) 3. In front and rear regions on a bottom side of the board 3, wheels 5 and 7 are provided, respectively. At a generally central region of a bottom surface of the board 3, a case is supported as shown in FIG. 5 and FIG. 6, which houses a motor controller 12 which preferably includes a drive motor controller (control circuit board) 9 and a battery 11 which defines a power source of the controller 9. The controller 9 and the battery 11 are preferably fixed on a bottom surface of the case 13. The battery 11 includes, for example, a plurality (for example, sixteen in the present preferred embodiment) of cells 11a which are electrically connected in series, for example, by welding. The cells 11a are defined by Ni—Cd battery cells, for example. Note that in FIG. 5 and FIG. 6, reference numeral “11b” indicates a connection portion, such as a weld joint, for example, at which mutually adjacent cells 11a are connected with each other.

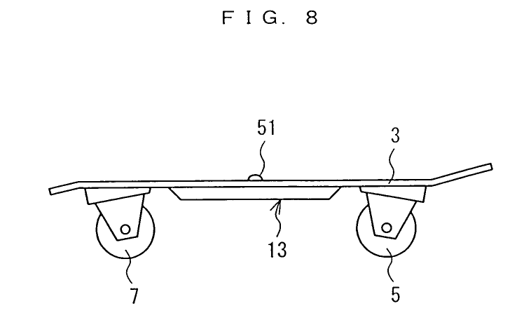

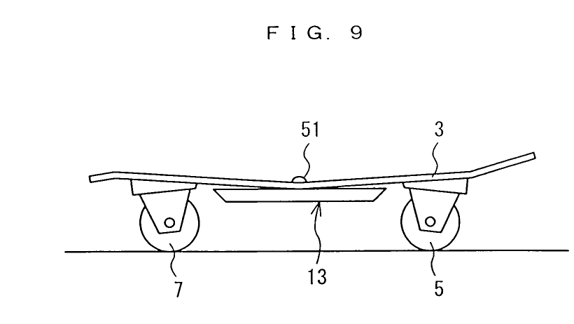

The board 3 is preferably made of flexible structural material such as plywood, so that it is generally horizontal as shown in FIG. 8 under no load, but flexes in vertical directions under a load as shown in FIG. 9, bringing a center portion into a downwardly recessed curve on a front and a rear wheels 5, 7 serving as fulcrums. Since the flexible structural material flexes in vertical directions, it provides improved operability by a rider's feet, providing suspension which improves riding comfort, as well as contributing to reduced weight. The flexible structural material should preferably have a spring coefficient between about 15 kg/cm and about 30 kg/cm. In the present preferred embodiment, a flexible structural material having an approximately 20 kg/cm spring coefficient (sagging about 1 cm under an approximately 20 kg load) is preferably used. The flexible structural material is also called flexibly bendable material.

Each of the wheels 5, 7 is preferably a single wheel. The wheel 5 in the front preferably serves as a free wheel whereas the wheel 7 at the rear preferably serves as a drive wheel which incorporates a drive motor 15.

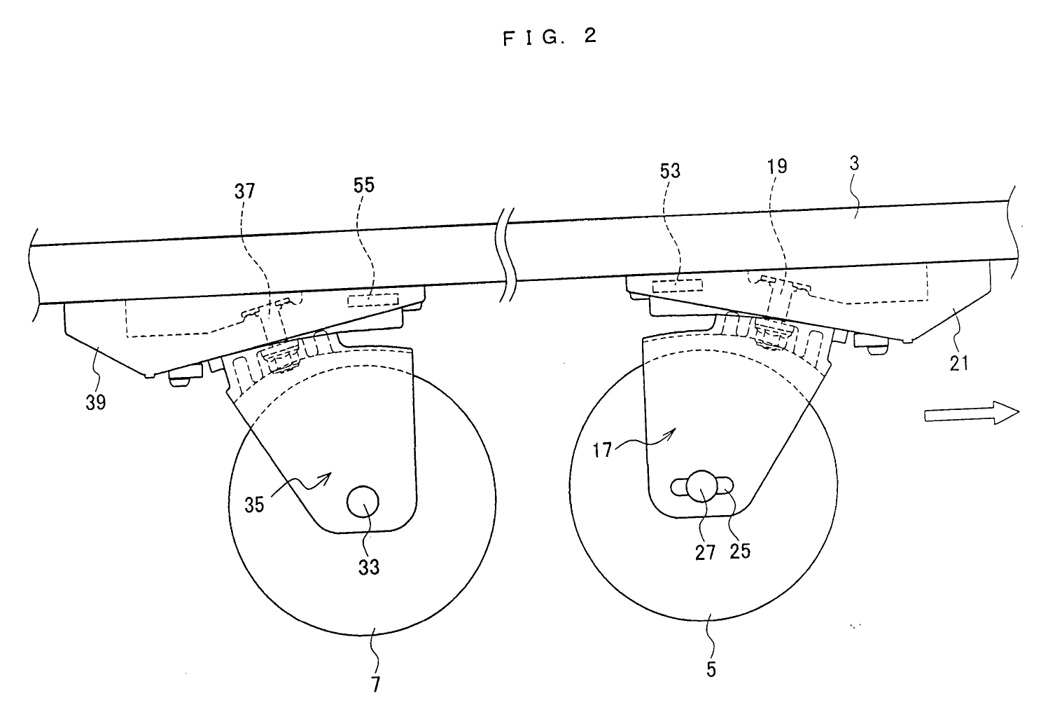

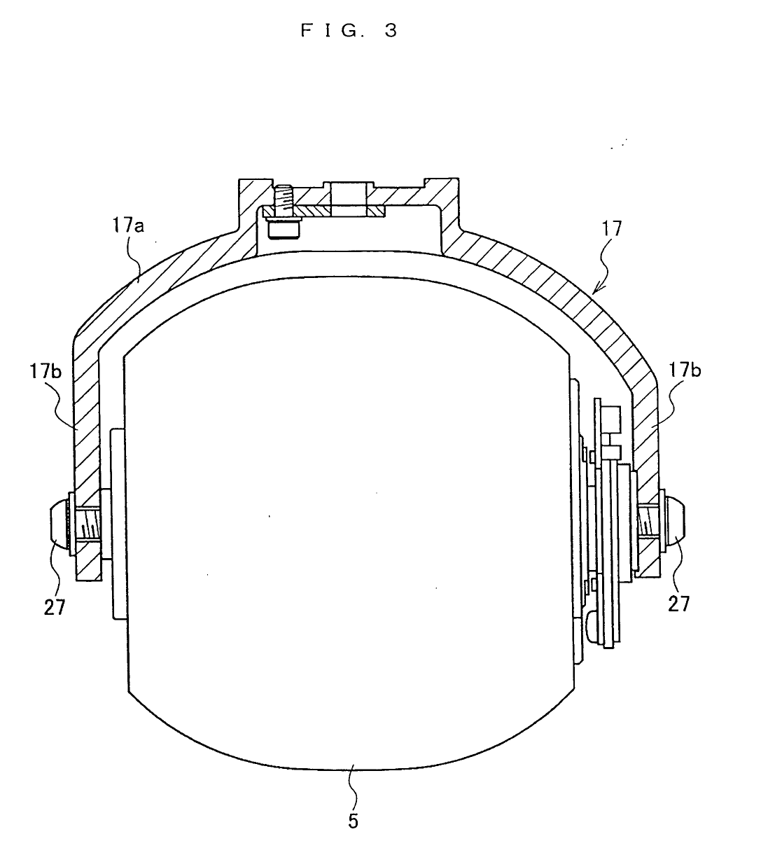

Referring to FIG. 2 and FIG. 3, the free wheel or the wheel 5 is rotatably supported by a supporting arm 17. The supporting arm 17 is preferably formed in a downward facing U, and includes an upper arm portion 17a, and right and left arm portions 17b. The upper arm portion 17a is supported pivotably freely in a range of 360 degrees by a fixed frame 21 via an arm shaft 19. As shown in FIG. 1, the fixed frame 21 is integrally fixed to and supported on a bottom surface of the board 3 by a plurality of fastening bolts 23, for example.

Each of the right and the left arm portions 17b has a long hole 25 which extends in forward and rearward directions. The long hole 25 is provided with a wheel attaching shaft 27 which rotatably supports the wheel 5. Therefore, the attaching location of the front wheel or the wheel 5 is adjustable within the long hole 25 by moving the wheel in the forward or rearward direction for a desired turning characteristic of the skateboard 1.

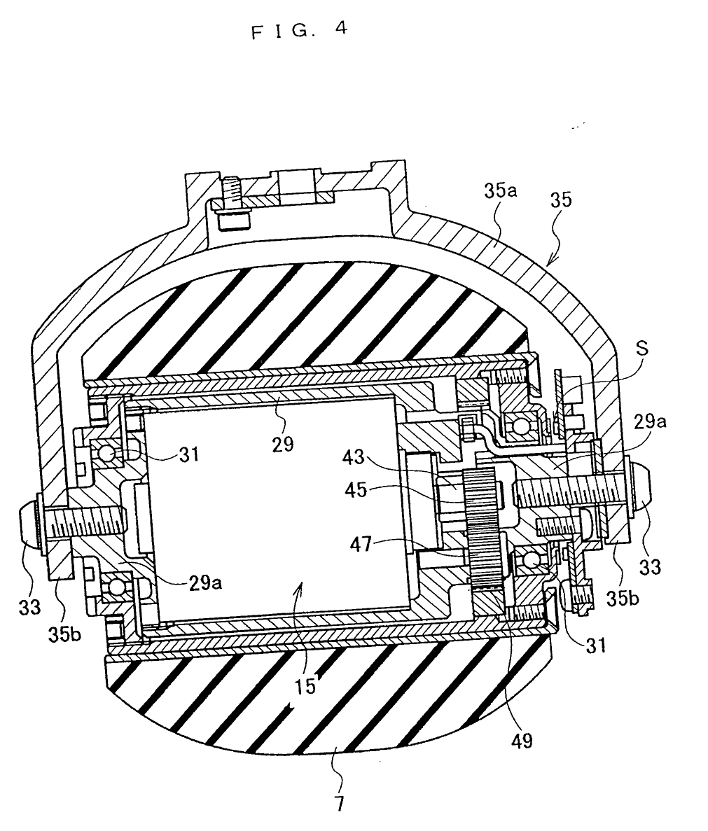

Referring to FIG. 2 and FIG. 4, a hollow fixed sleeve 29 is provided inside the drive wheel or the wheel 7, and the drive motor 15 is fixed within the fixed sleeve 29. A bearing 31 is provided on each side of the fixed sleeve 29. The bearings 31 rotatably support the wheel 7. The fixed sleeve 29 has two side portions 29a, each integrally fixed to and supported by a supporting arm 35 via a wheel attaching shaft 33.

The supporting arm 35 is preferably formed in a downward facing U, and includes an upper arm portion 35a, and right and left arm portions 35b which provides a fixed support to the side portions 29a of the fixed sleeve 29. The upper arm portion 35a is pivotable freely in a range of 360 degrees around an arm shaft 37, and is supported by a fixed frame 39. The fixed frame 39 is integrally fixed to and supported on a bottom surface of the board 3 by a plurality of fastening bolts 41, for example.

The drive motor 15 is controlled based on signals supplied from the controller 9, which is powered by a battery 11. A drive gear 45 is inserted around the motor shaft 43. The drive gear 45 engages with a middle gear 47, and the middle gear 47 engages with an internal gear 49 which is provided inside the wheel 7, whereby a rotating force after speed reduction in accordance with gear ratios between the gears is transmitted to the wheel 7.

As shown in FIG. 1 and FIG. 5, the controller 9 and the battery 11 are housed in a case 13, an approximately central region of which is fixed to and supported on the bottom surface of the board 3, with a fixing element such as fixing bolts 51, for example. Thus, front and rear ends of the case 13 are free ends. The fixing bolts 51 are preferably round-head bolts as shown in FIG. 5. Alternatively, flat-head bolts may be used so the heads will not protrude from the board 3. Many other fixing elements and materials may be used to fix the case 13 to the board 3.

A fixed support via the fixing bolt 51 may be a single-point support at the approximate central region or a multi-point support. If the multi-point support is used, preferably as shown in FIG. 1, the fixing bolts 51 are preferably arranged to be aligned along Line X which crosses the board 3, i.e., substantially perpendicularly to the longitudinal directions of the board 3.

The controller 9 is supplied with detection signals from a weight transfer detection sensor 53 located closer to the fore foot and a weight transfer detection sensor 55 placed closer to the rear foot as shown in FIG. 2. The weight transfer detection sensor 53 for the fore foot is attached to the fixed frame 21 which supports the wheel 5 whereas the weight transfer detection sensor 55 for the rear foot is attached to the fixed frame 39 which supports the wheel 7.

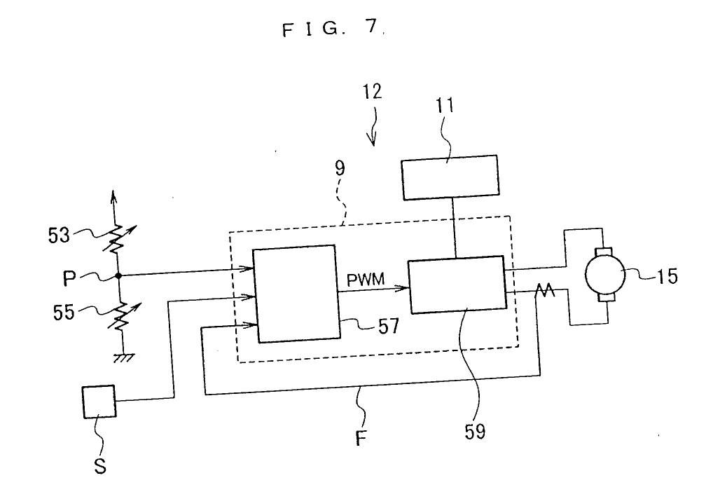

Referring to FIG. 7, the controller 7 includes a CPU 57 and a driver 59. The CPU 57 is supplied with a voltage at a voltage dividing point P of a voltage divider circuit which includes a series connection of the fore-foot and rear-foot weight transfer detection sensors 53, 55; a voltage from a speed sensor S provided by an encoder indicating the speed of wheel 7; and a drive current of the drive motor 15 supplied from a feedback circuit F. The CPU 57 and the driver 59 are mounted on a substrate which is preferably made of a material such as glass-epoxy resin or other suitable material.

The weight transfer detection sensors 53, 55 for the forward and the rearward feet preferably have the same resistance characteristic. When a load is applied from the fore foot, the resistance value of the fore foot weight transfer detection sensor 53 decreases in inverse proportion to the load. When a load is applied from the rear foot, the resistance value of the rear foot weight transfer detection sensor 55 decreases in inverse proportion to the load. Therefore, when there is no load or the same amount of load exerted on both of the detection sensors 53 and 55, the voltage at the voltage dividing point P of the voltage divider circuit becomes one half of voltage divider circuit source voltage V. On the other hand, when the rider transfers his weight on the board 3, to increase the load on the fore-foot weight transfer detection sensor 53 over the load on the rear-foot weight transfer detection sensor 55, the voltage becomes higher than V*½, by an amount that is proportional to the difference between the loads detected by the two detection sensors. Likewise, when the rider makes a weight transfer to decrease the load on the fore-foot weight transfer detection sensor 53 to become smaller than the load on the rear-foot weight transfer detection sensor 55, the voltage becomes lower than V*½, by an amount that is proportional to the difference between the loads detected by the two detection sensors.

The CPU 57 generates a drive command signal (PWM: Pulse Width Modulation signal) whose pulse width represents the voltage at the voltage dividing point P of the voltage divider circuit, and sends the signal to the driver 59 at the next stage of the circuit. Based on the drive command signal from the CPU 57, the driver 59 outputs a drive current to the drive motor 15.

According to the skateboard 1 as described above, when the rider on the board 3 transfers his weight to his fore foot, the CPU 57 sends to the driver 59 a drive command signal which has a pulse width representing the difference between the loads on the forward-foot side and the rearward-foot side. The drive motor 15 is supplied with a drive current corresponding to the pulse width, and begins to accelerate or to travel forward. On the other hand, when the rider transfers his weight to his rear foot, the CPU 57 sends to the driver 59 a drive command signal which has a pulse width representing the difference between the loads on the forward-foot side and the rearward-foot side (a drive command signal which has a reverse amplitude of the amplitude when the weight transfer is to the fore foot). The drive motor 15 is supplied with a drive current corresponding to the pulse width, and begins to decelerate or to travel rearward.

According to the skateboard 1 as described above, the case 13 is fixed at its generally central region by the fixing bolts 51, for example, thereby freeing up the front and rear ends of the case 13. Therefore, even if the load from the rider is applied to the board 3 and a generally central region of the board 3 deflects in a downward direction on the fulcrums provided by the front and the rear wheels 5, 7 (e.g., even if a state change occurs from a state in FIG. 8 to a state in FIG. 9), the case 13 is not deformed, and there is no adverse influence on the motor controller 12 including the drive motor controller 9 and the battery 11 which are susceptible to deflection. Therefore, it becomes possible for example, to prevent a weld joint 11b from coming off the battery 11a, resulting in an electrically open circuit between the batteries 11a. Further, since the board 3 is not subject to a resisting force from the case 13 against the deflection of the board 3, good operability by the rider's feet is obtained, and a natural comfortable ride can be assured due to suspension.

Further, the motor controller 12 supplies the wheel 7 with a rotary power in accordance with detection signals from the weight transfer detection sensors 53, 55. This makes possible to provide good control on the drive of the wheel 7 in accordance with the weight transfer of the rider.

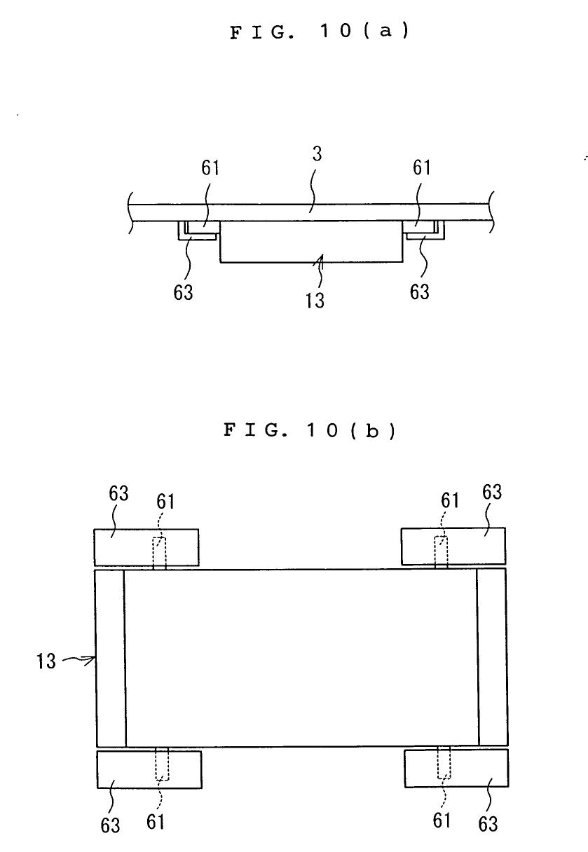

Next, FIGS. 10(a) and (b) show another preferred embodiment in which a case 13 is supported on the bottom surface side of the board 3.

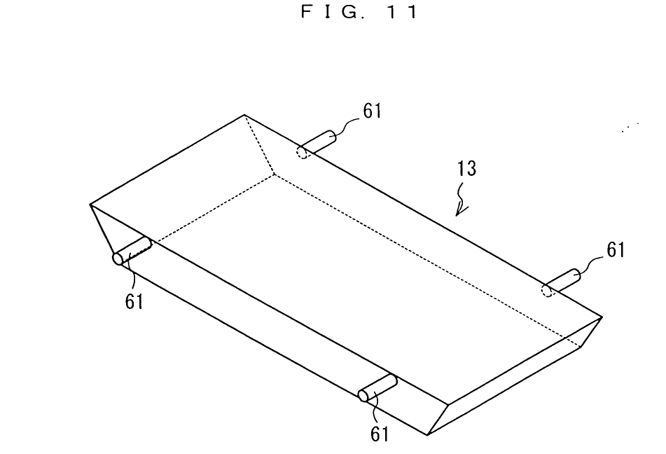

In the present preferred embodiment, as clearly understood from FIG. 11, the case 13 preferably includes four rod members 61 on its two longitudinal side surfaces, each of the rod members extending substantially perpendicularly to the side surface at a place closer to a longitudinal end of the side surface. On the other hand, the board 3 has a bottom surface provided with four guide rails 63, each of which has a generally L-shaped section and serves as supports for the rod members 61. As clearly understood from FIG. 10(b), each guide rail 63 is provided at a location corresponding to one of the rod members 61, and supports the rod member 61. Under this state, the center region of the case 13 is free.

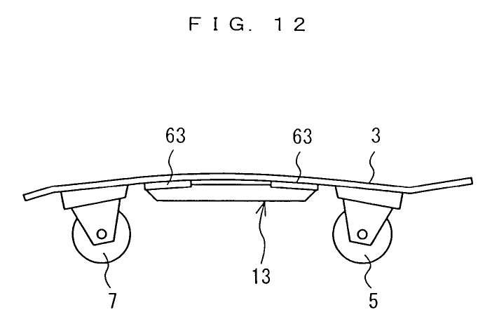

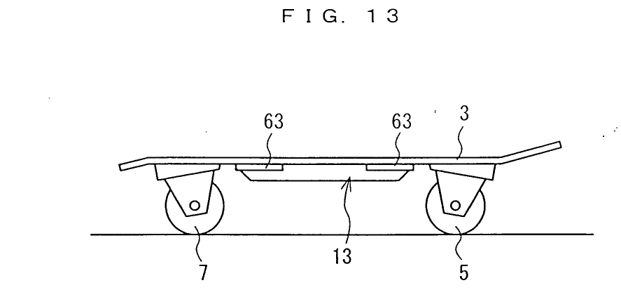

As shown in FIG. 12, the board 3 is upwardly curved under no load. The rod members 61 are non-slidingly supported by the guide rails 63. On the other hand, the board 3 flexes to become flat under a load as shown in FIG. 13, and the rod members 61 in the case 13 becomes slidable in the fore-and-aft directions with respect to the guide rails 63. Other arrangements are the same as in the previous preferred embodiment, so the description of these common features will not be repeated here.

According to the present preferred embodiment, even when the rider applies a load onto the board 3, causing a generally central region of the board 3 to be displaced (flexed) in the vertical directions, the guide rails 63 which support the case 13 moves in the fore-and-aft directions according to the amount of displacement, i.e. the front guide rails 63 move forward and the rear guide rails move rearward, reducing the deformation load, vibration and so on exerted on the case 13. Use of the skateboard under such a condition does not deform the case 13 and so there is no adverse influence on the motor controller 12 including the controller 9, the battery 11 and so on. Further, since the board 3 is not subject to a resisting force applied from the case 13 against the deflection of the board 3, good operability by the rider's feet is obtained, and a natural comfortable ride can be assured due to suspension.

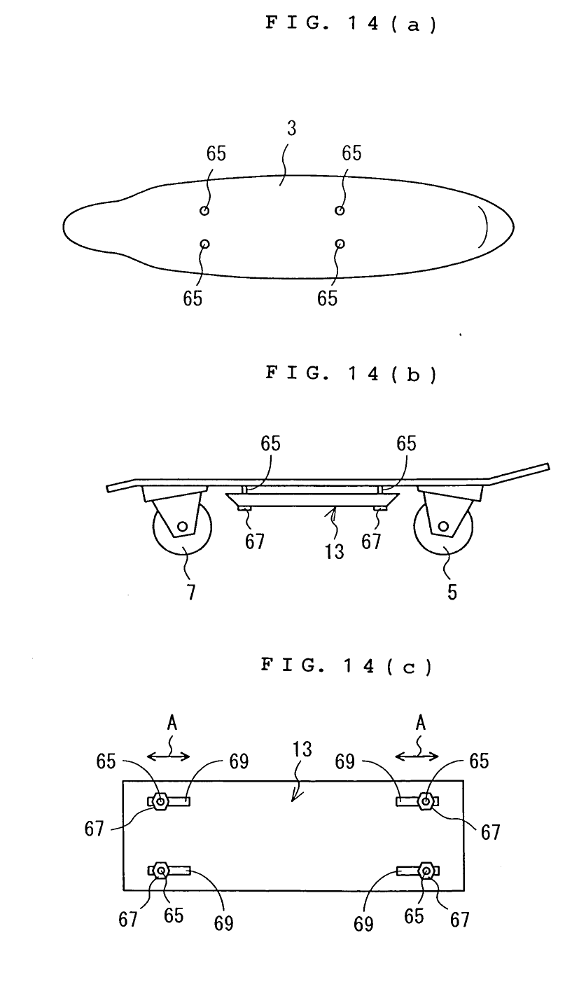

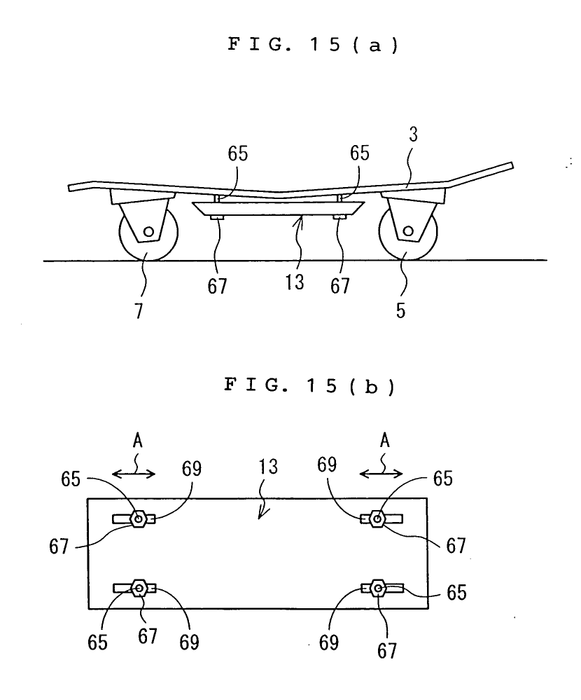

Next, FIGS. 14(a)-(c) and FIGS. 15(a) and (b) show another preferred embodiment in which a case 13 is supported on the bottom surface side of a board 3.

In the present preferred embodiment, four sets of bolts 65 and nuts 67 are preferably used as supports, and the case 13 is provided with four long through holes 69 for insertion of the bolts 65. The bolts 65 should preferably be flat-headed so that the heads of bolts 65 will not protrude on the upper surface of the board 3 but will become flush with it.

Using the bolts 65 and the nuts 67 as described above, the case 13 is suspended on the bottom surface side of the board 3 spaced at a distance therefrom, as shown in FIG. 14 under no load. Under a load, the board 3 flexes downward as shown in FIG. 15, and the bolts 65 move in the long holes 69 toward the center of the board 3. Other arrangements are the same as in the previous preferred embodiments, so description of the common features will not be repeated here.

According to the present preferred embodiment, even when the rider applies his load onto the board 3, causing a generally central region of the board 3 to be displaced (flexed) in vertical directions, the bolts 65 and the nuts 67 which support the case 13 move in the directions indicated by Arrow A (in FIG. 14 and FIG. 15), according to the amount of displacement, reducing the deformation load, vibration and so on exerted on the case 13. Use of the skateboard under such a condition does not deform the case 13 and so there is no adverse influence on the motor controller 12 including the controller 9, the battery 11 and so on. Further, since the board 3 is not subject to a resisting force from the case 13 against the deflection of the board 3, good operability by the rider's feet is obtained, and a natural comfortable ride can be assured due to suspension.

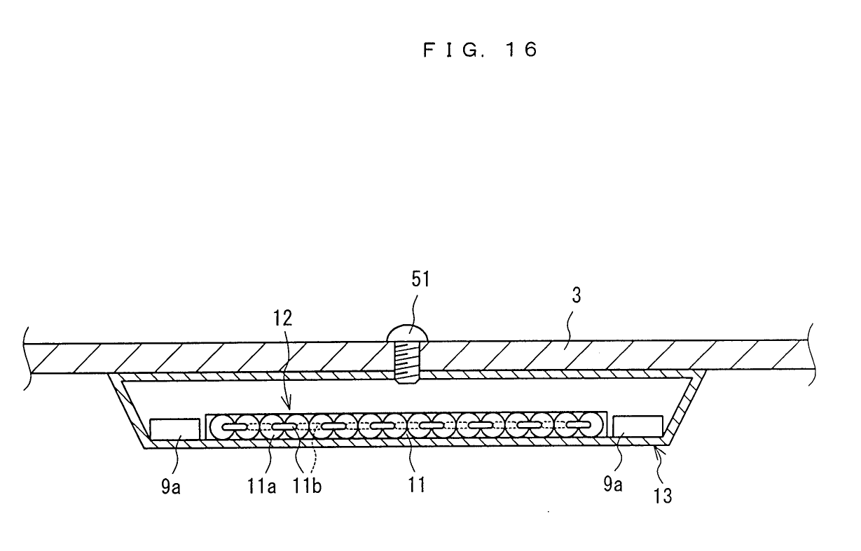

It should be noted here that not only the rear wheel 7 but also the front wheel 5 may be a drive wheel. In this case, the wheel 5 is also provided with a drive motor 15. When both of the wheels 5, 7 serve as the drive wheels, it is preferable as shown in FIG. 16, that two controllers 9a are used respectively for the wheels 5, 7, and the controllers 9a should be housed in the case 13.

Further, the fixing element arranged to fix a generally central portion of the case 13 onto the bottom surface of the board 3 is not limited to the fixing bolt 51, but may be constituted by other fixing elements or materials such as an adhesive.

The board 3 is not limited to wood, but may be made of other flexible structural members such as a synthetic resin.

The present invention being thus far described and illustrated in detail, it is obvious that these descriptions and drawings only represent examples of preferred embodiments of the present invention, and should not be interpreted as limiting the present invention. The spirit and scope of the present invention is only limited by words used in the following claims.

1-6. (canceled)

7. A skateboard comprising:
a board;
wheels provided on a bottom surface of the board, at front and rear regions thereof;
a motor controller arranged to supply at least one of the wheels with rotary power;
a case provided on the bottom surface of the board and housing the motor controller; and
at least one fixing element arranged to fix a substantially central region of the case to the board so as to leave front and rear end regions of the case free.

8. The skateboard according to claim 7, further comprising a weight transfer detection sensor arranged to detect a weight transfer of a rider riding on the board, wherein the motor controller is arranged to receive a detection signal from the weight transfer detection sensor and supply said at least one wheel with the rotary force in accordance with the detection signal received from the weight transfer detection sensor.

9. The skateboard according to claim 7, wherein the board is made of a flexible structural material.

10. The skateboard according to claim 7, wherein the motor controller includes at least one of a motor drive controller and a battery.

11. The skateboard according to claim 10, wherein the controller includes a plurality of batteries, the batteries being electrically connected with each other.

12. The skateboard according to claim 7, wherein the case is fixed directly to the bottom surface of the board.

13. The skateboard according to claim 7, wherein the case is slidingly attached to the bottom surface of the board.

14. The skateboard according to claim 7, wherein the case is suspended from the bottom surface of the board.

15. The skateboard according to claim 7, wherein the fixing element includes at least one of a plurality of bolts and an adhesive.

16. The skateboard according to claim 11, wherein said at least one of the motor drive controller and the battery are spaced from the bottom surface of the board.

17. A skateboard comprising:
a board;
wheels provided on a bottom surface of the board, at front and rear regions thereof;
a motor controller arranged to supply at least one of the wheels with rotary power;
a case provided on the bottom surface of the board and housing the motor controller; and
a support arranged to support the case on the bottom surface of the board, and being arranged to move longitudinally along the board at least when a load is applied on the board.

18. The skateboard according to claim 17, wherein the case includes elongated holes and fixing element located within the elongated holes to enable the case to move in a direction along a length of the elongated holes when a load is applied on the board.

19. The skateboard according to claim 17, wherein the support includes at least one guide rail and at least one guide member arranged to move along the at least one guide rail.

20. The skateboard according to claim 17, wherein the board is made of a flexible structural material.

21. The skateboard according to claim 17, wherein the motor controller includes at least one of a motor drive controller and a battery.

22. The skateboard according to claim 21, wherein the controller includes a plurality of batteries, the batteries being electrically connected with each other.

23. The skateboard according to claim 17, wherein the case is fixed directly to the bottom surface of the board.

24. The skateboard according to claim 17, wherein the case is slidingly attached to the bottom surface of the board.

25. The skateboard according to claim 17, wherein the case is suspended from the bottom surface of the board.

26. The skateboard according to claim 21, wherein said at least one of the motor drive controller and the battery are spaced from the bottom surface of the board.
